(19) United States
(12) Patent Application Publication
(10) Pub. No.: US 2025/0289250 A1
(43) Pub. Date: Sep. 18, 2025

(54) INKJET RECORDING APPARATUS AND CONVEYANCE CONTROL METHOD

(71) Applicant: Konica Minolta, Inc., Tokyo (JP)

(72) Inventor: Shinichi NAGAO, Tokyo (JP)

(21) Appl. No.: 19/080,410

(22) Filed: Mar. 14, 2025

(30) Foreign Application Priority Data
Mar. 18, 2024 (JP) 2024-042254

(51) Int. Cl. B41J 13/22; B41J 11/00; B41J 13/00

(52) U.S. Cl. CPC B41J 13/226; B41J 11/002; B41J 11/0095; B41J 13/0027

(57) ABSTRACT

Provided is an inkjet recording apparatus including an image forming section, a cylindrical conveyance mechanism, a heating section, a switching section, and a hardware processor. The image forming section forms an image by discharging ink onto a recording medium. The cylindrical conveyance mechanism conveys the recording medium. The heating section heats an outer circumferential surface of the conveyance mechanism. The switching section switches a conveyance path of the recording medium between a first conveyance path that does not pass between the conveyance mechanism and the heating section and a second conveyance path that passes between the conveyance mechanism and the heating section. The hardware processor controls switching of the conveyance path by the switching section in accordance with a printing mode. When causing the switching section to select the second conveyance path, the hardware processor stops heating by the heating section.

### CROSS-REFERENCE TO RELATED APPLICATIONS

The entire disclosure of Japanese Patent Application No. 2024-042254 filed on Mar. 18, 2024, is incorporated herein by reference in its entirety.

### BACKGROUND OF THE INVENTION

### Technical Field

The present invention relates to an inkjet recording apparatus and a conveyance control method.

### Description of Related Art

In recent years, apparatuses of a type in which ink is discharged from nozzles of inkjet heads (hereinafter, also referred to simply as “heads”) have become widespread (hereinafter, such apparatuses are also referred to simply as “inkjet recording apparatuses”). In an inkjet recording apparatus, it is important to ensure the wetting and spreading of ink discharged from nozzles of a head onto a recording medium and the uniformity of the ink. The wetting and spreading of the ink on the recording medium, the uniformity of the ink, and the like are ensured by appropriately controlling the temperature of the recording medium.

For example, it is assumed that the temperature of a recording medium deviates from the target temperature when ink discharged from nozzles of a head lands on the recording medium to record an image. In this case, there is a concern that the wetting and spreading of the ink dots deteriorate and the quality of the recorded image is compromised. The target temperature is an optimum temperature corresponding to the intended use of the image.

In a conventional inkjet recording apparatus, the temperature (thermal energy) of a conveyance mechanism that conveys a recording medium has been propagated to the recording medium by controlling the temperature of the conveyance mechanism. Then, the temperature of the conveyance mechanism has been controlled for the purpose of keeping the temperature of the recording medium from deviating from the target temperature.

For example, International Publication No. 2016/190335 discloses an inkjet recording apparatus including a drum heater for heating an outer circumferential surface of an image forming drum.

However, in a state where heating control of a conveyance mechanism such as a conveyance drum by a heating section such as a drum heater is executed, when a recording medium is conveyed between the conveyance mechanism and the heating section, there is a risk that the recording medium may catch fire or emit smoke. Therefore, the conveyance path that does not pass between the conveyance mechanism and the heating section is selected during execution of the heating control of the conveyance mechanism by the heating section.

However, depending on the printing mode of the recording medium, it may be desirable to convey the recording medium along a conveyance path that passes between the conveyance mechanism and the heating unit. Such a printing mode includes, for example, an additional white printing mode. In the additional white printing mode, an image is further formed with white ink on the recording medium after image formation. That is, image formation on a recording medium is performed in two batches.

In such a printing mode, it is necessary to convey the recording medium again to the position of the head in a state where the ink landed on the surface of the recording medium in the first rotation of the conveyance mechanism is uncured. When the ink landed on the recording medium in the first rotation is cured at that time, the wettability of the recording medium changes. Then, if ink is ejected onto the recording medium in the second rotation of the conveyance in a state where the wettability of the recording medium has changed, the ink may be repelled by the surface of the recording medium.

When the recording medium is conveyed again to the position of the head with the ink being in an uncured state, the recording medium needs to be conveyed without being turned over. This is because if the front and back of the recording medium are reversed, the uncured ink adheres to the conveyance member. Therefore, the recording medium needs to be conveyed without passing through a reversing mechanism that reverses the front and back of the recording medium. As a path for conveying the recording medium without passing through a reversing mechanism, there is a path for causing the recording medium to make another round on the outer peripheral surface of the conveyance mechanism.

However, the outer circumferential surface of the conveyance mechanism is heated by the above-described heating section. Therefore, when control is performed to cause the recording medium to make another round on the outer circumferential surface of the conveyance mechanism, the recording medium is heated by the heating section. When the recording medium is heated by the heating section, the recording medium may catch fire. WO2016190335A1 does not mention the necessity of conveying the recording medium along a conveyance path passing between the conveyance mechanism and the heating section, or describe a method for realizing such conveyance.

The present invention has been conceived in view of solving the above-described problem. An object of the present invention is to make it possible for a recording medium on which an image has been recorded to be conveyed on a conveyance path that passes between a conveyance mechanism and a heating section without the recording medium catching fire.

### SUMMARY OF THE INVENTION

To achieve at least one of the abovementioned objects, according to an aspect of the present invention, an image forming apparatus reflecting one aspect of the present invention includes:
an image forming section that forms an image by discharging ink onto a recording medium;
a cylindrical conveyance mechanism that conveys the recording medium;
a heating section that heats an outer circumferential surface of the conveyance mechanism;
a switching section that switches a conveyance path of the recording medium between a first conveyance path that does not pass between the conveyance mechanism and the heating section and a second conveyance path that passes between the conveyance mechanism and the heating section; and
a hardware processor that controls switching of the conveyance path by the switching section in accordance with a printing mode,
wherein, when causing the switching section to select the second conveyance path, the hardware processor stops heating by the heating section.

According to another aspect of the present invention, a conveyance control method includes:
formation of an image by discharging ink onto a recording medium;
conveyance of the recording medium by a cylindrical conveyance mechanism;
heating of an outer circumferential surface of the conveyance mechanism by a heating section;
switching, by a switching section, of a conveyance path of the recording medium between a first conveyance path that does not pass between the conveyance mechanism and the heating section and a second conveyance path that passes between the conveyance mechanism and the heating section; and control of the switching of the conveyance path by the switching section in accordance with a printing mode;
wherein in the control, heating by the heating section is stopped when the switching section is caused to select the second conveyance path.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a side view showing an example of a schematic configuration of an inkjet recording apparatus according to an embodiment of the present invention;

FIG. 2 is a perspective view showing an example of a configuration of a temperature control recording cylinder according to an embodiment of the present invention

FIG. 3 is a block diagram showing an example of a hardware configuration of an inkjet recording apparatus according to an embodiment of the present invention;

FIG. 4 is a diagram showing an example of conveyance paths to be switched by a conveyance path switching section according to an embodiment of the present invention;

FIG. 5 is a flowchart showing an example of a procedure of conveyance control processing when the first printing mode is set according to an embodiment of the present invention; and

FIG. 6 is a flowchart which shows an example of a procedure of conveyance control processing when the second printing mode is set according to an embodiment of the present invention.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described in detail with reference to the drawings. In the present specification and drawings, elements having substantially the same function or configuration are denoted by the same reference numerals, and redundant descriptions of the constituent elements are omitted.

### <Schematic Configuration of Inkjet Recording Apparatus>

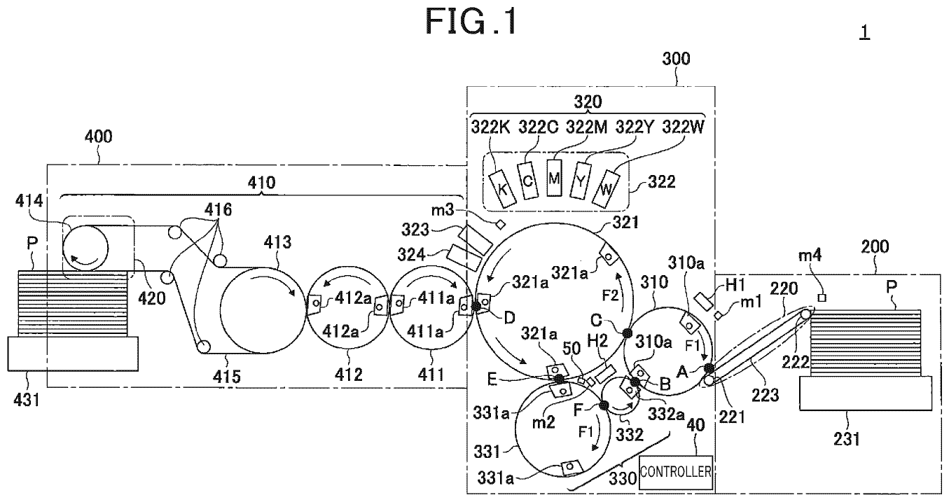

FIG. 1 is a side view showing an example of a schematic configuration of an inkjet recording apparatus 1 according to the present embodiment. As shown in FIG. 1, the inkjet recording apparatus 1 includes a feeding device 200, a recording device 300, and an ejection device 400.

### 1. Feeding Device

The feeding device 200 includes a feeding tray 231, a feeder 220, and a temperature sensor m4. The feeding tray 231 is a tray for storing recording media P. The feeder 220 feeds a recording medium P from the feeding tray 231 to the recording device 300. The temperature sensor m4 measures the temperature of the recording medium P.

### 1. 1. Feeding Tray

The feeding tray 231 is a plate-like member on which a plurality of recording media P cut in a predetermined size are placed in a stacked state. The feeding tray 231 moves up and down according to the amount of recording media P placed thereon. The position of the feeding tray 231 is adjusted to a position where the uppermost recording medium P is supplied to the temperature control conveyance cylinder 310 of the recording device 300 by the feeder 220.

The feeding tray 231 includes a movable arm (not illustrated) having a suction portion. The movable arm sucks one sheet of the uppermost layer of the feeding tray 231 and conveys the sheet to the feeder 220.

### 1. 2. Feeder

The feeder 220 includes a ring-shaped feeding belt 223. The inner side of the ring-shaped feeding belt 223 is supported by a plurality of rollers, for example, two rollers 221 and 222. As the rollers 221 and 222 rotate with the recording medium P placed on the feeding belt 223, the recording medium P is supplied to the recording device 300 along the feeding belt 223.

### 1. 3. Temperature Sensor

The temperature sensor m4 is formed of, for example, a non-contact infrared detection sensor. The temperature sensor m4 is installed at a position facing the uppermost recording medium P on the feeding tray 231, and measures the temperature of the recording medium P. The temperature sensor m4 then outputs the measured temperature of the uppermost recording medium P to a controller 40 (hardware processor) in the recording device 300.

### 1. 4. Recording Media

The recording media P placed on the feeding tray 231 is, for example, flat cut sheets. Examples of the flat cut sheets include normal paper sheets ranging from thin paper to cardboard, high-quality paper sheets, coated print sheets such as art paper or coated paper, water-soluble paper sheets, Japanese paper sheets, and postcard sheets. The material of the recording medium P is not limited to paper. Furthermore, the recording medium P may be, for example, a plastic film, fabric, or leather. The color of the recording medium P is also not limited to white.

### 2. Recording Device

As shown in FIG. 1, the recording device 300 according to the present embodiment includes a temperature control conveyance cylinder 310, a recording mechanism 320, a temperature control recording cylinder 321, an image reading section 324, and a reversing mechanism 330.

The temperature control conveyance cylinder 310 conveys the recording medium P to the recording mechanism 320 while supporting the recording medium P along the outer circumferential surface thereof. The recording medium P fed from the feeder 220 included in the feeding device 200 or the recording medium P delivered from the second reversing cylinder 332 of the reversing mechanism 330 is fed to the temperature control conveyance cylinder 310. A heater H1 for heating the outer circumferential surface of the temperature control conveyance cylinder 310 is provided in the vicinity of the temperature control conveyance cylinder 310. Then, the recording medium P is conveyed on the outer circumferential surface of the temperature control conveyance cylinder 310 heated by the heater H1, whereby heat of the temperature control conveyance cylinder 310 is propagated to the recording medium P. When the temperature of the heating by the heater H1 is adjusted by the controller 40, the temperature of the recording medium P conveyed along the temperature control conveyance cylinder 310 is also adjusted.

The recording mechanism 320 (an example of an image forming section) includes a temperature control recording cylinder 321 and an inkjet recording section 322. The temperature control recording cylinder 321 conveys the recording medium P delivered from the temperature control conveyance cylinder 310 while adjusting the temperature. The inkjet recording section 322 forms (records) an image on the recording medium P conveyed on the temperature control recording cylinder 321. The inkjet recording section 322 includes heads 322W, 322Y, 322M, 322C, and 322K (each of which is an example of an image forming unit).

The head 322W is an ink head that ejects white ink onto the recording medium P, and the head 322Y is an ink head that ejects yellow ink onto the recording medium P. The head 322M is an ink head that ejects magenta ink onto the recording medium P, and the head 322C is an ink head that ejects cyan ink onto the recording medium P. The head 322K is an ink head that ejects black ink onto the recording medium P. The heads 322W, 322Y, 322M, 322C, and 322K are arranged at predetermined intervals in this order from the upstream side in the conveyance direction of the recording medium P.

The recording mechanism 320 according to the present embodiment can perform printing according to a plurality of printing modes. The plurality of printing modes includes a background printing mode, an additional white printing mode, an image reading mode, and the like. The background printing mode is a mode in which first, a background is formed on a transparent plastic film by solid coating with white ink or the like, and then an image is formed on the recording medium P after the background formation. Note that the color of the image printed as the background in the background printing mode is not limited to white, and may be other colors.

The additional white printing mode is a mode for forming an image with white ink, such as a highlighted portion and white characters, on the recording medium P on which the image has been formed. The background printing mode and the additional white printing mode are examples of a first printing mode in which an image is formed on the same surface of the recording medium P in each of the first rotation and the second rotation of the conveyance by the conveyance mechanism (the temperature control recording cylinder 321).

In the first printing mode, fixing by the ink curing and drying device 323 is performed at the point in time when image formation on the recording medium P in both the first rotation and the second rotation of conveyance by the temperature control recording cylinder 321 has been completed. This is because when the fixing processing is performed on the recording medium P on which the image is formed in the first rotation of the conveyance, the wettability or the like of the recording medium P changes. When the wettability of the recording medium P changes, there is a possibility that the recording medium P repels the ink ejected from the inkjet recording section 322 in the second rotation.

Therefore, the recording medium P needs to be conveyed again to the position of the inkjet recording section 322 in a state where the ink landed on the recording medium P in the first rotation of conveyance is not yet cured. At this time, when the recording medium P is conveyed using a reversing mechanism 330 which will be described later, the front and back of the recording medium P are reversed. Then, when the front and back of the recording medium P are inverted, the uncured ink on the recording medium P adheres to the outer peripheral portion of the reversing mechanism 330.

Therefore, in the present embodiment, in the first printing mode, the recording medium P after image formation is not delivered to the reversing mechanism 330 and is made to make another round along the temperature control recording cylinder 321. This control is performed by the controller 40 instructing the conveyance path switching section 20 described later to switch the conveyance destination of the recording medium P.

The image reading mode is a mode in which the image reading section 324 reads an image subsequent to image formation by the recording mechanism 320, and is an example of a second printing mode. In the image reading mode, image formation on the recording medium P by the recording mechanism 320 is performed in the first rotation of conveyance by the temperature control recording cylinder 321. Then, in the second rotation, the recording medium P on which the image is formed is read by the image reading section 324. That is, also in the image reading mode, the controller 40 controls the recording medium P after image formation to make another round along the temperature control recording cylinder 321.

In the present embodiment, in the second print mode, the controller 40 also performs control to change the conveyance speed between the first rotation and the second rotation of the conveyance of the recording medium P by the temperature control recording cylinder 321. More specifically, the controller 40 changes the conveyance speed in the second rotation of the conveyance to a lower speed than the conveyance speed in the first rotation. By performing such control by the controller 40, it is possible to increase the resolution of the reading of the recording medium P by the image reading section 324 performed in the second round of the conveyance.

The control of changing the conveyance speed in the second rotation to a low speed is performed, for example, when an image inspection is performed for the purpose of detecting a discharge failure, a deviation in the landing position of ink, the concentration of ink, or the like. This is because in these image inspections, a high-resolution read image needs to be generated.

In addition, the recording mechanism 320 is provided with a conveyance path switching section 20. The conveyance path switching section 20 switches the conveyance destination of the recording medium P on which an image has been recorded to any one of the temperature control recording cylinder 321, the ejection mechanism 410, and the reversing mechanism 330. When the conveyance destination of the recording medium P is set to the temperature control recording cylinder 321 by the conveyance path switching section 20, the recording medium P makes another round of the temperature control recording cylinder 321.

The reversing mechanism 330 includes a first reversing cylinder 331 and a second reversing cylinder 332. The first reversing cylinder 331 reverses the front and back of the recording medium P delivered from the recording mechanism 320, and delivers the reversed recording medium P to the second reversing cylinder 332. The second reversing cylinder 332 delivers the recording medium P delivered from the first reversing cylinder 331 to the temperature control conveyance cylinder 310 via the conveyance path that does not pass through between the heater H2 and the temperature control recording cylinder 321.

### 2. 1. Conveyance Mechanism

### 2. 1. 1. Temperature Control Conveyance Cylinder

The conveyance mechanism according to the present embodiment includes the temperature control conveyance cylinder 310. The temperature control conveyance cylinder 310 conveys the recording medium P fed from the feeder 220 of the feeding device 200 or the recording medium P conveyed from the second reversing cylinder 332 to the temperature controlled recording cylinder 321. As described above, the temperature control conveyance cylinder 310 has a function of conveying the recording medium P while controlling the temperature thereof.

In the present embodiment, the circumferential length of the temperature control conveyance cylinder 310 is, for example, a length that is substantially twice or more the maximum length of the recording medium P, which is a flat cut sheet, in the conveyance direction. As the circumferential length of the temperature control conveyance cylinder 310 is set to such a length, the length of the recording medium P in contact of the temperature control conveyance cylinder 310 can be increased. Thus, the temperature of the recording medium P can be stably adjusted.

The heater H1, which is a temperature adjustment member of the temperature control conveyance cylinder 310, is installed in the vicinity of the temperature control conveyance cylinder 310. The heater H1 is, for example, a non-contact heater that emit infrared rays, such as a halogen lamp.

In one specific example, the temperature control conveyance cylinder 310 is formed of a known Peltier device or the like that operates under the control of the controller 40. The Peltier device is a Peltier roller in which a sheet-like element thermoelectric conversion device is incorporated. As the polarity (+ or −) of a voltage to be applied to the sheet-like element is switched, the element thermoelectric conversion device switches between a cooling operation and a heating operation.

The heater H1 is operated under the control of the controller 40, and radiates heat for heating (preheating) the temperature control conveyance cylinder 310. Thus, prior to the image recording process, the temperature control conveyance cylinder 310 and the recording medium P conveyed on the outer circumference of the temperature control conveyance cylinder 310 are heated to a predetermined temperature. The image recording process includes an image recording process on the front surface of the recording medium P and an image recording process on the back surface.

As the temperature adjustment member, a blowing fan for heating or cooling, a roller and a belt with a built-in thermoelectric conversion device, or the like can also be used.

A thermal sensor m1 is installed in the vicinity of the heater H1. The temperature sensor m1 detects the temperature of the temperature control conveyance cylinder 310 and outputs information on the detected temperature to the controller 40. As a temperature detection element of the temperature sensor m1, a non-contact type element such as a thermopile can be used. A contact-type element such as a thermocouple and thermistor may be used as the temperature detection element of the temperature sensor m1.

The controller 40 controls, based on the temperature detected by the temperature sensor m1, the heating operation or the cooling operation of the heaters H1 so that the outer circumferential surface of the temperature control conveyance cylinder 310 reaches a predetermined temperature.

### 2. 1. 2. Handover of Recording Medium

The temperature control conveyance cylinder 310 includes a claw portion 310a for receiving and delivering the recording medium P. The claw portion 310a is openable and closable, and holds a leading end part of the recording medium P in the conveyance direction in a closed state. The claw portion 310a is provided with a cam mechanism (not illustrated). The cam mechanism is a mechanism that opens and closes each of the plurality of claws forming the claw portion 310a. The cam mechanism closes the claw portion 310a when the recording medium P is received, and opens the claw portion 310a when the recording medium P is sent. The operation of the cam mechanism is controlled by the controller 40 based on the information of the conveyance destination of the recording medium P switched by the conveyance path switching section 20.

There are three handover positions of the recording medium P with respect to the temperature control conveyance cylinder 310, which are a position A, a position B, and a position C described below.
Position A: A position where the recording medium P is delivered from the feeder 220 of the feeding device 200 to the temperature control conveyance cylinder 310.
Position B: A position where the recording medium P is delivered from the second reversing cylinder 332 of the reversing mechanism 330 to the temperature control conveyance cylinder 310.
Position C: A position where the recording medium is delivered from the temperature control conveyance cylinder 310 to the temperature control recording cylinder 321.

From the viewpoints of shortening the conveyance path and suppressing an increase in the size of the apparatus, it is preferable that the position B and the position C are on the downstream side of the position A in the conveyance direction and the position B is between the position A and the position C.

The second reversing cylinder 332 is provided with one claw portion 332a, and the temperature control conveyance cylinder 310 is provided with two claw portions 310a at intervals of 180°. Furthermore, the temperature control recording cylinder 321 is provided with three claw portions 321a at intervals of 120°. When the temperature control recording cylinder 321 rotates by 120° in the counterclockwise direction F2 in FIG. 1, the first reversing cylinder 331 rotates in the clockwise direction F1. Next, when the first reversing cylinder 331 rotates in the clockwise direction F1, the second reversing cylinder 332 rotates once in the counterclockwise direction F2. When the second reversing cylinder 332 rotates once in the counterclockwise direction F2, the temperature control conveyance cylinder 310 rotates 180° in the clockwise direction F1.

As shown in FIG. 1, the position A is opposite to the position C with the temperature control conveyance cylinder 310 interposed therebetween. Since the position A is formed at such a position, it is possible to increase the amount wound around the temperature control conveyance cylinder 310 of the recording medium P fed from the feeding device 200. That is, since a sufficient contact time with the recording medium P can be ensured, the temperature of the recording medium P can be stably adjusted.

### 2. 2. Recording Mechanism

The recording mechanism 320 includes a temperature control recording cylinder 321 and an inkjet recording section 322.

### 2. 2.1. Temperature Control Recording Cylinder

The temperature control recording cylinder 321 receives the recording medium P conveyed from the temperature control conveyance cylinder 310, and while bearing the recording medium P on the outer peripheral surface thereof, controls the temperature of the recording medium P and conveys it. The temperature control recording cylinder 321 delivers the recording medium P, which has been temperature-controlled and conveyed, to the ejection mechanism 410 or the reversing mechanism 330.

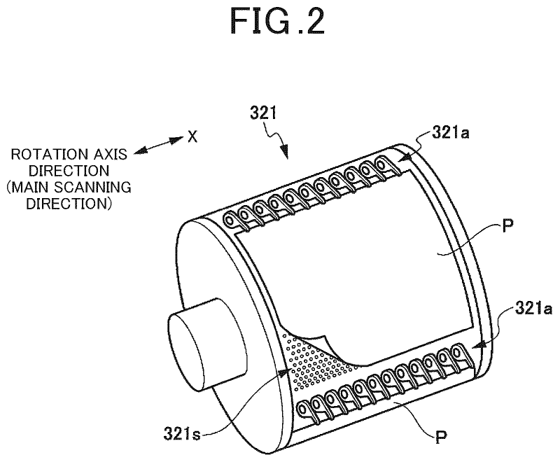

Here, the configuration of the temperature control recording cylinder 321 will be described with reference to FIG. 2. FIG. 2 is a perspective view showing a configuration example of the temperature control recording cylinder 321. As shown in FIG. 2, the temperature control recording cylinder 321 is provided with claw portions 321a and suction portions 321s for bearing the recording media P on the outer circumferential surface thereof.

The claw portion 321a is composed of a plurality of claws. The plurality of claws are arranged at predetermined intervals along the rotation axis direction of the temperature control recording cylinder 321 (the sub-scanning direction by the inkjet recording section 322). Further, the claw portion 321a includes a cam mechanism (not shown). The cam mechanism operates such that claws open and close at positions facing the temperature control conveyance cylinder 310, a cylinder 411 included in the ejection mechanism 410 to be described later, and a first reversing cylinder 331, respectively.

Specifically, for example, the claw portion 321a holds one end of the recording medium P by being brought into a closed state at a timing at which one end of the recording medium P is delivered from the temperature control conveyance cylinder 310. In addition, the claw portion 321a enters an open state at a timing when one end of the recording medium P is delivered to the cylinder 411, the first reversing cylinder 331, or the like included in the ejection mechanism. Thus, one end of the recording medium P is delivered to the claw portion 411a of the cylinder 411 or the claw portion 331a of the first reversing cylinder 331.

Further, the temperature control recording cylinder 321 has three holding areas of the recording medium P obtained by equally dividing the outer peripheral surface thereof. That is, the temperature control recording cylinder 321 can hold a maximum of three recording media P. The number of holding areas of the recording medium P in the temperature control recording cylinder 321 is not limited to three.

The suction portion 321s includes a plurality of suction holes provided on the outer circumferential surface of the temperature control recording cylinder 321, and a suction force generating section (not illustrated). The suction force generation section generates a suction force for sucking gas into the temperature control recording cylinder 321 via the suction holes. Examples of the member used for the suction force generation section include a blower and a fan. By the suction force generated by the suction force generation section, the recording medium P conveyed on the outer circumferential surface of the temperature control recording cylinder 321 is attracted to and along the outer peripheral surface of the temperature control recording cylinder 321.

The hollow interior of the temperature control recording cylinder 321 is divided into three sections corresponding to the holding areas of the three recording media P. The temperature control recording cylinder 321 also includes an intake circuit (not illustrated). The intake circuit is a circuit capable of individually selecting and applying a suction force to each of the suction portions 321s of the three holding regions of the temperature control recording cylinder 321. With such a configuration, the temperature control recording cylinder 321 can be operated not to apply the suction force to the holding area not holding the recording medium P.

FIG. 2 shows a state in which a part of the recording medium P is turned up from the outer circumferential surface of the temperature control recording cylinder 321, but this is for the purpose of illustrating the suction holes. Actually, at the time of image recording by the inkjet recording section 322, the entire recording medium P is carried along the outer peripheral surface of the temperature control recording cylinder 321.

Referring back to FIG. 1, the description is continued. The temperature control recording cylinder 321 is provided with a cylinder rotation motor (not shown). The cylinder rotation motor is driven based on the control of the controller 40. As the temperature control recording cylinder 321 is rotated in the counterclockwise direction F2 by an angle proportional to the rotation amount of the cylinder rotation motor, the recording medium P is conveyed by the temperature control recording cylinder 321.

The heater H2 is arranged at a position facing a portion along the outer circumferential surface from the position E to the position C in the rotation (conveyance) direction (counterclockwise direction F2) of the temperature control recording cylinder 321. The position E is a place where the recording medium P is delivered from the temperature control recording cylinder 321 to the first reversing cylinder 331.

The heater H2 (an example of the heating section) operates under the control of the controller 40 to radiate heat for preheating the temperature control recording cylinder 321, thereby heating the temperature control recording cylinder 321 to a predetermined temperature.

When the above-described control is performed in which the recording medium P after image formation is made to make another round by the temperature control recording cylinder 321, the recording medium P is conveyed between the heater H2 and the temperature control recording cylinder 321. At this time, if heating by the heater H2 is continued, the recording medium P may catch fire. Therefore, in the present embodiment, the controller 40 performs control to turn off the heating by the heater H2 when control is performed to cause the recording medium P after image formation to make another round by the temperature control recording cylinder 321.

A temperature sensor m2 is installed near the heater H2. The temperature sensor m2 detects the temperature of the temperature control conveyance cylinder 310, and outputs information on the detected temperature to the controller 40. The temperature detection elements of the temperature sensors m2 may be the same as those of the temperature sensor m1 described above.

A recording medium detector 50 is provided at an upstream position in the conveyance direction of the recording medium P in the vicinity of the temperature sensor m2. The recording medium detector 50 is constituted by, for example, a reflective sensor or the like, and detects the recording medium P conveyed by the temperature control recording cylinder 321. Then, the recording medium detector 50 outputs the detection result to the controller 40.

In a case where the above-described control in which the recording medium P after image formation is made to make another round by the temperature control recording cylinder 321 is not performed, the recording medium P is conveyed along a conveyance path which does not pass between the heater H2 and the temperature control recording cylinder 321. That is, the recording medium P is conveyed along a conveyance path passing through the first reversing cylinder 331, the second reversing cylinder 332, and the temperature control conveyance cylinder 310 and returning to the temperature control recording cylinder 321 again. Therefore, the recording medium P does not pass between the heater H2 and the temperature control recording cylinder 321 when a conveyance path that does not pass between the heater H2 and the temperature control recording cylinder 321 is selected by the conveyance path switching section 20. If the recording medium P passes between the heater H2 and the temperature control recording cylinder 321, it is due to an erroneous entry of the recording medium P. The recording medium detector 50 is a sensor that detects an erroneous entry of the recording medium P.

When the recording medium detector 50 detects an erroneous entry of the recording medium P, the controller 40 performs control for ejecting the recording medium P from the ejection mechanism 410. By performing such control by the controller 40, it is possible to prevent the erroneously entered recording media P from being heated by the heater H2.

When the recording medium P after image formation is controlled to make another round by the temperature control recording cylinder 321, the controller 40 turns off the detection of the recording medium P by the recording medium detector 50. When the controller 40 performs such control, the recording medium P is not detected by the recording medium detector 50. That is, it is possible to prevent the recording medium P from being ejected to the ejection tray 431 by the ejection mechanism 410. Therefore, the recording medium P after the image formation can be made to make another round by the temperature control recording cylinder 321. As described above, heating by the heater H2 is also turned off during execution of the control in which the recording media P after image formation is made to make another round by the temperature control recording cylinder 321. Therefore, the recording medium P is not heated by the heater H2.

### 2. 2. 2. Handover of Recording Medium

The temperature control recording cylinder 321 includes three claw portions 321a for transferring the recording medium P. Since the structure of the claw portion 321a is the same as that of the claw portion 310a, description thereof will be omitted. In the temperature control recording cylinder 321, the three claw portions 321a are provided at intervals of 1200 around the rotation axis of the temperature control recording cylinder 321. There are three handover positions of the recording medium P with respect to the temperature control recording cylinder 321, which are a position C, a position D, and a position F described below.
Position C (described in the delivery position of the recording medium P related to the temperature control conveyance cylinder 310)
Position D: A portion where the recording medium P is delivered from the temperature control recording cylinder 321 to the cylinder 411 of the ejection mechanism 410.
Position E: A place where the recording medium P is delivered from the temperature control recording cylinder 321 to the first reversing cylinder 331 of the reversing mechanism 330.

For example, in double-sided printing, the recording medium P is conveyed from the temperature control recording cylinder 321 to the temperature control recording cylinder 321 again via the reversing mechanism 330 and the temperature control conveyance cylinder 310. In this case, the claw portion 321a provided on the cylinder on the upstream side in the conveyance direction is controlled to open, and the claw portion 321a provided on the cylinder on the downstream side in the conveyance direction is controlled to close. By controlling the opening and closing of the claw portions 321a in this way, one end of the recording medium P is sequentially delivered from the cylinder on the upstream side in the conveyance direction to the cylinder on the downstream side in the conveyance direction.

### 2. 2.3. Inkjet Recording Section

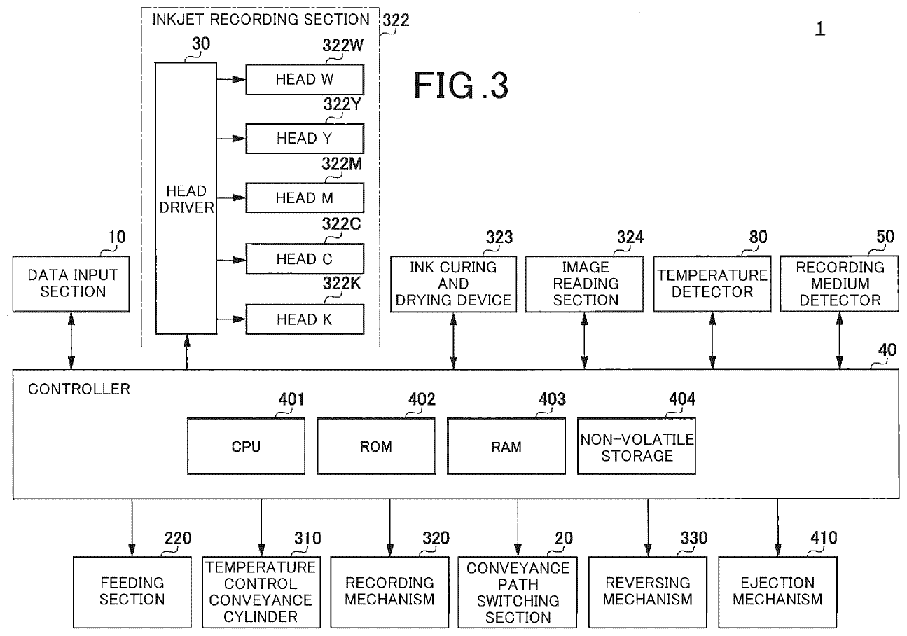

The inkjet recording section 322 applies ink to one side of the recording medium P to record an image. The inkjet recording section 322 includes heads 322W, 322Y, 322M, 322C, and 322K. The inkjet recording section 322 includes a head driver 30 (see FIG. 3) that drives these heads.

Each of the heads 322W, 322Y, 322M, 322C, and 322K has nozzle openings (not illustrated) for discharging ink onto the recording medium P. The nozzle openings are provided on an ink ejection face facing the conveyance surface of the temperature control recording cylinder 321. The ink is applied to the recording medium P as the ink is discharged from the nozzle opening portion onto the recording medium P at appropriate timings corresponding to the rotation of the temperature control recording cylinder 321 on which the recording medium P is held. Then, an image is recorded on the recording medium P by application of ink onto the recording medium P.

### Inkjet Heads

The distances between the respective ink ejection faces of the heads 322W, 322Y, 322M, 322C, 322K and the conveyance surface of the temperature control recording cylinder 321 are set to be predetermined fixed distances. In addition, in each of the heads 322W, 322Y, 322M, 322C, and 322K, a plurality of nozzles that individually discharge ink are provided in the direction orthogonal to the conveyance direction of the recording media P.

The inkjet recording section 322 includes an ink tank (not illustrated) that stores ink and supplies the ink to each head. Each inkjet recording section 322 may be provided with an ink heater or the like as a means for heating ink before ejection.

An ink path from the ink tank to each of the heads 322W and 322Y, the 322M, the 322C, and the 322K is provided with a supply-pressure adjustment mechanism (not illustrated). The supply pressure from the supply pressure adjustment mechanism is adjusted to a pressure slightly lower than the atmospheric pressure. By adjusting the supply pressures to such pressures, it is possible to prevent the ink from spilling out from the nozzles of each of the heads 322W, 322Y, 322M, 322C, and 322K.

The head driver 30 provides driving signals based on the control of the controller 40. The drive signal is a signal for deforming the piezoelectric element in accordance with image data at an appropriate timing for each head. As each of the heads 322W, 322Y, 322M, 322C, and 322K is driven based on the drive signal, an amount of ink corresponding to a pixel value is discharged from each nozzle.

### Ink

For example, active ray curable ink can be used as the ink. The curing characteristics of the active ray curable ink are often susceptible to the influence of temperature. Therefore, since the temperature adjustment of the temperature control recording cylinder 321 is optimized when the ink is used, it is possible to perform more satisfactory image recording with stable quality.

As the active ray curable ink, for example, an ink having a property of being cured by irradiation with ultraviolet rays can be used. The energy rays for curing the ink are not limited to ultraviolet rays. The energy ray may be another energy ray such as an infrared ray or an electron beam. In addition, a light source of an ink curing and drying device 323 which will be described later is replaced according to the type of energy ray.

Furthermore, the active ray curable ink may contain other components, if necessary. Examples of the other components include a gelling agent, a polymerization initiator, a polymerization inhibitor, a coloring material such as a dye and a pigment, a dispersant, a fixing resin, a surfactant, a pH adjuster, a humectant, and an ultraviolet absorber. The composition may contain only one of the other components, or may contain two or more of the other components.

In addition, the ink is preferably a phase-change ink from the viewpoint of performing good image recording with stable quality. It is preferable that the phase change in the ink occurs before and after the ink is recorded on the recording medium P.

When the ink includes a solid component containing a coloring material and a solvent component, the ink curing and drying device 323 may be configured as a drying device that evaporates the solvent component. Examples of the drying device include non-contact type drying devices such as an infrared heater and a hot-air blower.

### 2. 2.4. Ink Curing and Drying Device

In a case where a UV curable ink is used as the ink, for example, an LED, a high-pressure mercury lamp, or the like is used for a light emitting portion (not illustrated) of the ink curing and drying device 323 (an example of a fixing section). The ink curing and drying device 323 emits active rays such as ultraviolet rays from the light emitting portion to the recording medium P held on the temperature control recording cylinder 321. Accordingly, a polymerization reaction occurs in the ink on the recording medium P, and the ink on the recording medium P is cured and fixed on the recording medium P.

The light source of the light emitting portion is not limited to an LED or a high-pressure mercury lamp. For example, as the light source, a mercury lamp having an operating pressure of about several hundred [Pa] to 1 mega [Pa], a light source available as a bactericidal lamp, or the like may be used. Furthermore, a cold-cathode tube, an ultraviolet laser light source, a metal halide lamp, or the like may be used as the light source. It is desirable that the light source of the light emitting portion be a power-saving light source that can emit ultraviolet rays with higher illuminance.

The ink curing and drying device 323 is provided in the vicinity of the outer circumferential surface of the temperature control recording cylinder 321. More specifically, the ink curing and drying device 323 is provided on the downstream side of the inkjet recording section 322 and on the upstream side of the conveyance path switching section 20 in the conveyance direction of the recording medium P. Since the ink curing and drying device 323 is arranged at such a position, the ink on the recording medium P is cured and dried before the recording medium P reaches the position of the conveyance path switching section 20.

### Temperature Sensor Near Inkjet Recording Section on Downstream Side

A temperature sensor m3 is installed in the vicinity on the downstream side of the inkjet recording section 322 and on the upstream side of the ink curing and drying device 323. The temperature sensor m3 detects the temperature of the recording medium P and outputs the temperature to the controller 40. The temperature sensors m3 can also detect the temperature of the surface of the temperature control recording cylinder 321 when the recording media P are not passing therethrough.

### 2. 3. Image Reading Section

The image reading section 324 is provided downstream of the ink curing and drying device 323. The image reading section 324 includes, for example, an in-line sensor, and optically reads the entire surface of the recording medium P conveyed on the outer circumferential surface of the temperature control recording cylinder 321. Then, the image reading section 324 outputs the read image obtained by reading to the controller 40.

As described above, in the image reading mode in which high-resolution image reading is required, the controller 40 performs control to reduce the conveyance speed in the second rotation of the conveyance by the temperature control recording cylinder 321. To be specific, the controller 40 sets the conveyance speed of the temperature control recording cylinder 321 at the time of image formation in the first rotation of conveyance to 3000 sph (sheets per hour) or 6000 sph. At the time of image reading in the second rotation, the controller 40 reduces the conveyance speed of the temperature control recording cylinder 321 to 750 sph or the like. By execution of such control by the controller 40, it is possible to improve the reading resolution in the sub-scanning (conveyance) direction of the recording medium P on which an image has been formed.

### 2. 4. Reversing Mechanism

The reversing mechanism 330 is a mechanism that reverses the front and back of the recording medium P of which one surface is coated with ink and delivers the recording medium P of which the front and back are reversed to the temperature control conveyance cylinder 310.

The reversing mechanism 330 includes a first reversing cylinder 331 and a second reversing cylinder 332. The first reversing cylinder 331 receives the recording medium P from the temperature control recording cylinder 321 at the position E. Next, the first reversing cylinder 331 delivers the received recording medium P to the second reversing cylinder 332 at the position F. The second reversing cylinder 332 delivers the received recording medium P to the temperature control conveyance cylinder 310 at the position B. The temperature control conveyance cylinder 310 delivers the recording medium P received at the position B to the temperature control recording cylinder 321 at the position C. By the reversing mechanism 330 operating in this manner, the front and back of the recording medium P delivered from the temperature control recording cylinder 321 are reversed, and the reversed recording medium P is again transferred to the temperature control recording cylinder 321.

The diameter of the first reversing cylinder 331 is, for example, substantially twice the diameter of the second reversing cylinder 332. The rotational operations of the first reversing cylinder 331 and the second reversing cylinder 332 are controlled by motors (hereinafter referred to as “independent drive motors”: not illustrated) that are independent drive sources.

### 2. 4. 1. Handover of Recording Medium

The first reversing cylinder 331 has two claw portions 331a. Each claw portion 331a is openable and closable, and holds a leading end part of the recording medium P in the conveyance direction in a closed state. Next, each rotational operation of the first reversing cylinder 331 and the second reversing cylinder 332 is controlled by each independent drive motor. Specifically, the independent drive motors control the timing at which the end portion that is not pinched by the claw portion 331a reaches the position F. More specifically, the independent drive motors control the rotational operational of the first reversing cylinder 331 and the second reversing cylinder 332 so that the end portion of the ungripped recording medium P reaches the position F at timing when the claw portion 331a of the first reversing cylinder 331 and the claw portion 332a of the second reversing cylinder 332 reach the position F. Next, the independent drive motor performs control to close the claw portion 332a of the second reversing cylinder 332 at the timing when the claw portion 332a of the second reversing cylinder 332 passes the position F. By execution of such control by the independent drive motor, the second reversing cylinder 332 receives the end portion of the recording medium P. Thereafter, when the claws of the claw portion 331a of the first reversing cylinder 331 open the recording medium P at a predetermined position, the recording medium P is delivered from the first reversing cylinder 331 to the second reversing cylinder 332.

In addition, when the claw portion 332a of the second reversing cylinder is rotated to the position B which is a close facing position with the temperature control conveyance cylinder 310 in a state where the claw portion 332a is gripping the end portion of the recording medium P, the claw portion 332a of the second reversing cylinder is controlled to open. At the same time, the claw portion 310a of the temperature control conveyance cylinder 310 that has reached the position B is controlled to close.

As the recording medium P is conveyed in this manner by the reversing mechanism 330, the reversed recording medium P is returned to the temperature control recording cylinder 321 without passing between the heater H2 and the temperature control recording cylinder 321. Therefore, it is possible to prevent the recording medium P whose front and back are inverted from catching fire and prevent the recording medium P from emitting smoke.

### 3. Ejection Device

The ejection device 400 according to the present embodiment includes the ejection mechanism 410. The ejection mechanism 410 conveys the recording medium P conveyed from the conveyance path switching section 20 to the ejection tray 431.

### 3. 1. Ejection Mechanism

As shown in FIG. 1, the ejection mechanism 410 according to the present embodiment includes cylinders 411 to 413, an ejection chain 415, a plurality of gears 414, and a plurality of tension gears 416. The cylinder 411 receives the recording medium P from the temperature control recording cylinder 321. The cylinder 412 receives the recording medium P from the cylinder 411. The plurality of ejection chains 415 receive the recording medium P from the cylinder 412 and deliver the recording medium P to the ejection section 420. The gears 413 drive the ejection chains 415. The tension gears 416 apply tension to each of the gears 414 and the ejection chains 415.

The cylinder 411 of the ejection mechanism includes two claw portions 411a that pinch one end portion of the recording medium P. Since the structure of the claw portion 411a is identical to that of the claw portion 321a of the temperature control recording cylinder 321, description thereof will be omitted.

When the claw portion 321a of the temperature control recording cylinder and the claw portion 411a of the cylinder 411 are at the position D of delivery from the temperature control recording cylinder 321 to the ejection mechanism 410, the plurality of claws of the claw portion 321a of the temperature control recording cylinder 321 are opened. In addition, the plurality of claws of the claw portion 411a of the case cylinder 411 are closed. Opening and closing of the claws 411a are performed by a cam mechanism (not illustrated) under the control of the controller 40. The recording medium P is transferred from the temperature control recording cylinder 321 to the cylinder 411 of the ejection mechanism 410 by the opening and closing operations of the claw portion by the cam mechanism.

### 3. 1. 1. Ejection Section

The cylinder 412 is also provided with two sets of claw portions 412a. The ejection chain 415 is also provided with a plurality of claw portions (not illustrated) at intervals of ½ of the circumferential lengths of the cylinder 411 and the cylinder 412. Further, the cylinder 412 is provided with a cam mechanism (not illustrated). The cam mechanism opens and closes a plurality of claws included in each claw portion of the cylinder 411 and the cylinder 412 at a position where the cylinder 411 and the cylinder 412 face each other. In addition, the cam mechanism opens and closes the claws included in each claw portion of the body 411 and the ejection chain 415 at a position where the cylinder 411 and the ejection chain 415 face each other.

The recording medium P is delivered from the cylinder 411 via the cylinder 412 to the ejection chain 415. Next, as the claws of the claw portion of the ejection chain 415 are opened at the position of the ejection section 420, the recording medium P is placed on the ejection tray 431.

The ejection section 420 stores the recording medium P after image recording on the ejection tray 431 until the recording medium P is picked up by the user.

### 4. Conveyance Path Switching Section

The conveyance path switching section 20 (see FIG. 3, an example of a switching section) switches a conveyance destination of the recording medium P on which an image is formed by the inkjet recording section 322 to any one of the ejection mechanism 410, the reversing mechanism 330, and the temperature control recording cylinder 321.

When single-sided printing is executed by the inkjet recording section 322, the conveyance path switching section 20 sets the ejection mechanism 410 as the conveyance destination of the recording medium P on which an image has been formed. On the other hand, when double-sided printing is performed by the inkjet recording section 322, the first reversing cylinder 331 of the reversing mechanism 330 is set as the conveyance destination of the recording medium P on which an image has been formed on the front surface. Further, the conveyance path switching section 20 sets the cylinder 411 of the ejection mechanism 410 as the conveyance destination of the recording medium P on which images are formed on both the front and back surfaces.

Furthermore, in the additional white printing mode or the background printing mode, the conveyance path switching section 20 changes the conveyance destination of the recording medium P between the first rotation and the second rotation of the temperature control recording cylinder 321. More specifically, the conveyance path switching section 20 does not switch the conveyance destination of the recording medium P on which an image has been formed and ink has not been cured yet at the end of the first rotation. That is, the temperature control recording cylinder 321 is set as the conveyance destination of the recording medium P on which an image has been formed. As a result, the recording medium P makes another round of the temperature control recording cylinder 321. On the other hand, in the second rotation of the conveyance, the conveyance path switching section 20 switches the conveyance destination of the recording medium P to the ejection mechanism 410. By execution of such control, the recording medium P on which images are formed in the first and second rotations is ejected to the ejection tray 431.

Also in the image reading mode, the conveyance path switching section 20 does not switch the conveyance destination of the recording medium P on which an image has been formed at the end of the first rotation. That is, the temperature control recording cylinder 321 is rotated one more time. On the other hand, at the end of the second rotation, the conveyance path switching section 20 sets the ejection mechanism 410 as the conveyance destination of the recording medium P from which the image has been read in the second rotation.

### 5. Controller

The controller 40 adjusts the set temperature of the temperature adjustment member or the like in accordance with a desired image recording condition on the basis of temperature information output from each temperature sensor. The temperature control member is a general term for the temperature control conveyance cylinder 310, the temperature control recording cylinder 321, the heaters H1 and H2, and other temperature control members (not illustrated). Further, the controller 40 controls operations of the temperature control conveyance cylinder 310, the recording mechanism 320, the ejection mechanism 410, and the reversing mechanism 330.

The “image recording conditions” include the front surface ink amount, the sheet size, the front surface image size, the type of ink, the material of the recording medium P, the basis weight of the recording medium P, the temperature and humidity of the recording device 300, and the like. The front surface ink amount is the amount of ink constituting the ink image recorded on the front surface of the recording medium P. The front surface image size is a size of the image to be formed on the front surface of the sheet.

The controller 40 also instructs the conveyance path switching section 20 to set the conveyance destination of the recording medium P. For example, when single-sided printing is instructed in the print job, the controller 40 causes the conveyance path switching section 20 to switch the conveyance destination of the recording medium P after image formation to the cylinder 411 of the ejection mechanism 410. In addition, in a case where double-sided printing is instructed in the print job, the controller 40 causes the conveyance path switching section 20 to switch the conveyance destination of the recording medium P on which an image has been formed on the first surface to the first reversing cylinder 331 of the reversing mechanism 330. When the printing mode is the first mode, the controller 40 causes the conveyance path switching section 20 to set the temperature control recording cylinder 321 as the conveyance destination of the recording medium P on which an image has been formed on the first surface. When the printing mode is the first mode, the controller 40 performs control to turn off heating by the heater H2 and detection of the recording medium P by the recording medium detector 50.

Further, in a case where the printing mode is the second mode (image reading mode) and high-definition reading is required, the controller 40 performs control to reduce the conveyance speed of the recording medium P in the second rotation. The controller 40 may perform control of reducing the conveyance speed of the recording medium P in the second rotation when another printing mode such as the additional white printing mode is set. In the additional white printing mode, as the controller 40 reduces the conveyance speed of the temperature control recording cylinder 321 in the second revolution, the inkjet recording section 322 can draw a highlighted portion of an image, a white character, or the like with high definition.

### <Configuration of Control System of Inkjet Recording Apparatus>

Next, the configuration of the control system of the inkjet recording apparatus 1 according to the present embodiment will be described with reference to FIG. 3. FIG. 3 is a block diagram showing an example of the hardware configuration of the inkjet recording apparatus 1.

The inkjet recording apparatus 1 includes a data input section 10, the inkjet recording section 322, the ink curing and drying device 323, the image reading section 324, a temperature detector 80, and the recording medium detector 50. Furthermore, the inkjet recording apparatus 1 includes the feeder 220, the temperature control conveyance cylinder 310, the recording mechanism 320, the conveyance path switching section 20, the reversing mechanism 330, and the ejection mechanism 410.

The data input section 10 includes an input interface connected to an external device (not illustrated), a memory, and the like. The external device (not illustrated) is, for example, a personal computer (PC) or the like. As the memory, for example, a hard disk drive (HDD), a solid state drive (SSD), or the like is used. A dynamic random access memory (DRAM) or the like may be used in combination as the memory.

The data input section 10 acquires data related to a print job from an external device (not illustrated) under the control of the controller 40, and records the acquired print job in a memory or the like. The print job includes a job instruction including a printing mode, image data of an image to be printed, various kinds of setting data, and the like. When a print job is executed, the data input section 10 reads image data from the memory and outputs the image data to the head driver 30.

The inkjet recording section 322 and the ink curing and drying device 323 have been described with reference to FIG. 1, and therefore, description thereof is omitted.

The temperature detector 80 includes the temperature sensors m1 to m4. Since the temperature sensors m1 to m4 have been described with reference to FIG. 1, the description will not be repeated.

The recording medium detector 50 has also been described with reference to FIG. 1, and thus description thereof is omitted.

The controller 40 includes a central processing unit (CPU) 401, a read only memory (ROM) 402, a random access memory (RAM) 403, and a nonvolatile storage 404.

The CPU 401 reads, from the ROM 402, program code of software that implements each function according to the present embodiment, develops the program code in the RAM 403, and executes the program code. In the RAM 403, variables, parameters, and the like generated during arithmetic processing by the CPU 401 are temporarily written.

The controller 40 may include a processing device such as a micro-processing unit (MPU) instead of the CPU 401. Furthermore, in the controller 40, a CPU and an MPU may be used in combination. In addition, the controller 40 may be configured by a field-programmable gate array (FPGA), an application specific integrated circuit (ASIC), or the like.

As the nonvolatile storage 404, for example, a hard disk drive (HDD), a solid state drive (SSD), an optical disc, a nonvolatile memory card, or the like is used. In the non-volatile storage 404, in addition to an operating system (OS) and various parameters, a software program or the like for realizing each function according to the present embodiment is recorded. The program may be stored in ROM402.

The program is stored in the form of computer-readable program code, and the CPU 401 sequentially executes operations according to the program code. That is, the ROM 402 or non-volatile storage 404 is used as an example of a computer-readable non-transitory recording medium that stores a program executed by a computer.

The feeder 220, the temperature control conveyance cylinder 310, the recording mechanism 320, the conveyance path switching section 20, the reversing mechanism 330, and the ejection mechanism 410 have been described with reference to FIG. 1, and thus description thereof will be omitted.

### <Example of Conveyance Path Switched by Conveyance Path Switching Section>

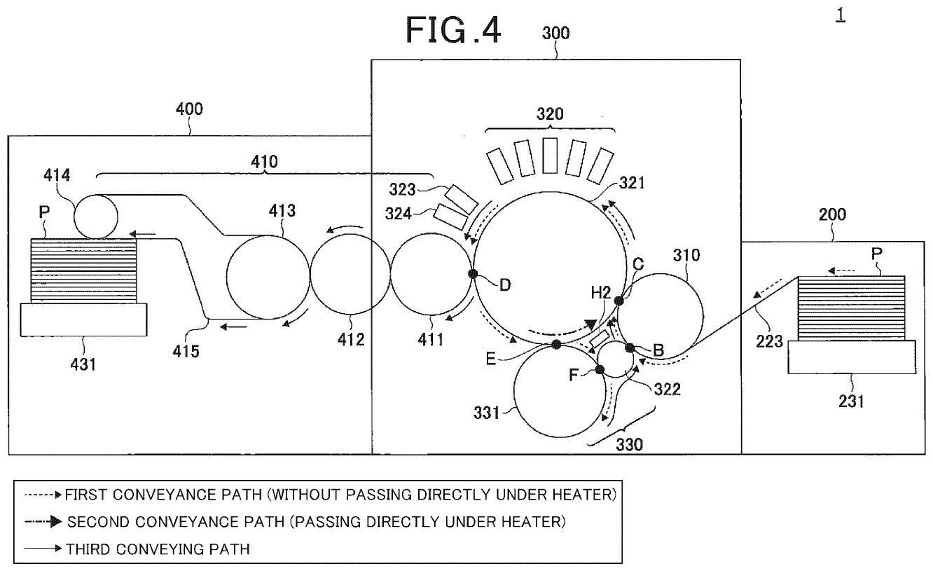

Next, the conveyance paths switched by the conveyance path switching section 20 will be described. FIG. 4 shows an example of the conveyance paths switched by the conveyance path switching section 20. FIG. 4 shows a simplified view of the inkjet recording apparatus 1 shown in FIG. 1. In FIG. 4, parts corresponding to FIG. 1 are denoted by the same numerals or symbols, and redundant description is omitted.

In the present embodiment, the conveyance path switching section 20 switches the conveyance path of the recording medium P to any of the following first to third conveyance paths under the control of the controller 40.

First Conveyance Path: a path that passes through the position B, the position C, the position D, the position E, the position F, and the position B in this order and returns to the position C again.

Second Conveyance Path: a path that passes through the position B, the position C, the position D, and the position E in this order and returns to the position C again.

Third Conveyance Path: a path along which a sheet passes through the position C and the position D and is ejected to the ejection tray 431.

The first conveyance path is a path indicated by a broken line arrow in FIG. 4. The first conveyance path is a path along which the recording medium P fed from the feeding device 200 is conveyed by the temperature control conveyance cylinder 310, the temperature control recording cylinder 321, the first reversing cylinder 331 and the second reversing cylinder 332 of the reversing mechanism 330, and the temperature control conveyance cylinder 310. After an image is formed by the inkjet recording section 322 on the recording medium P conveyed along the first conveyance path, the recording medium P is reversed by the reversing mechanism 330 and returned to the temperature control recording cylinder 321 again. In other words, the first conveyance path is a path that does not pass between the heater H2 and the temperature control recording cylinder 321 (described as “directly under heater” in the drawing). The first conveyance path is a path along which the recording medium P is conveyed for the first side in double-sided printing.

The second conveyance path is a path indicated by a one-dot chain line arrow in FIG. 4. The second conveyance path is a path along which the recording medium P fed from the feeding device 200 is conveyed by the temperature control conveyance cylinder 310 and the temperature control recording cylinder 321. In the second conveyance path, the recording medium P conveyed along the second conveyance path is conveyed one more round by the temperature control recording cylinder 321 after an image is formed by the inkjet recording section 322. That is, the second conveyance path is a path that passes between the heater H2 and the temperature control recording cylinder 321. The second conveyance path is a path selected by the conveyance path switching section 20 during conveyance of the recording medium P for the first rotation in the first printing mode or the second printing mode.

In a case where the second conveyance path is selected by the conveyance path switching section 20, the controller 40 performs control to turn off heating by the heater H2. Furthermore, the controller 40 also performs control to turn off detection by the recording medium detector 50. By execution of such control by the controller 40, it is possible to prevent the recording medium P in the first rotation of conveyance by the temperature control recording cylinder 321 from being heated by the heater H2. Further, it is possible to prevent the recording medium P in the first rotation conveyed by the temperature control recording cylinder 321 from being detected by the recording medium detector 50. That is, it is possible to prevent the recording medium P that should make another full round of the temperature control recording cylinder 321 from being erroneously conveyed to the ejection mechanism 410.

That is, according to the present embodiment, in the first printing mode such as the additional white printing mode or the background printing mode, the recording medium P with uncured ink can be returned to the position of the inkjet recording section 322 again without being delivered to the reversing mechanism 330. That is, it is possible to form an image on the recording medium P in the second rotation while preventing the uncured ink from adhering to the reversing mechanism 330.

Further, according to the present embodiment, in the image reading mode (second printing mode), the recording medium P on which an image has been formed can be made to make another round on the temperature control recording cylinder 321 without being ejected from the ejection mechanism 410. Thus, the controller 40 can perform control to change the conveyance speed of the recording medium P between the first rotation during which image formation is performed and the second rotation during which image reading is performed.

More specifically, the controller 40 can make the conveyance speed of the recording medium P in the second rotation lower than that in the first rotation. By execution of such control by the controller 40, it is possible to increase the resolution of image reading in the sub-scanning direction by the image reading section 324. Therefore, by using the read image by the image reading section 324, the controller 40 can detect the ejection failure of the ink, the deviation of the landing position of the ink, the density of the ink, and the like with high accuracy.

Further, in the present embodiment, in the image reading mode, it is possible to prevent the recording medium P on which an image has been formed before execution of image reading by the image reading section 324 from being ejected from the ejection mechanism 410. Therefore, according to the present embodiment, it is possible to save time and effort for the user to set the recording medium P on which image reading is desired to be performed in the feeding device 200 again.

The third conveyance path is a path indicated by a solid arrow in FIG. 4. The third conveyance path is a path along which the recording medium P on which an image has been formed in the first rotation of conveyance or an image has been formed on one surface (front face) is conveyed by the temperature control recording cylinder 321 and the ejection mechanism 410.

In the first printing mode, the recording medium P conveyed on the third conveyance path is subjected to fixing processing by the ink curing and drying device 323 after the image is formed with white ink by the inkjet recording section 322. Then, the recording medium P after the fixing processing is ejected to the ejection tray 431 by the ejection mechanism 410.

In the second printing mode, the recording medium P conveyed along the third conveyance path is ejected to the ejection tray 431 by the ejection mechanism 410 after image reading by the image reading section 324.

### <Conveyance Control Processing by Inkjet Recording Apparatus>

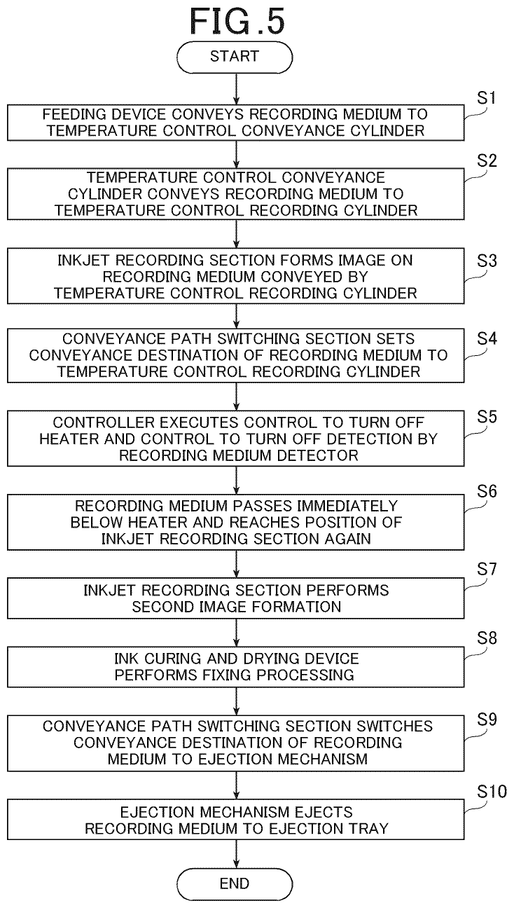

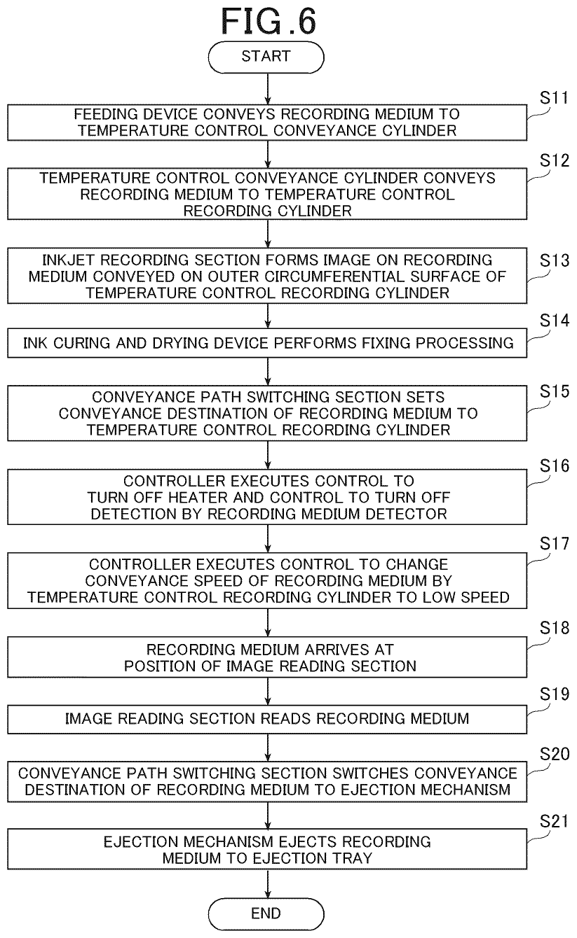

Next, conveyance control processing by the inkjet recording apparatus 1 according to the present embodiment will be described. FIG. 5 is a flowchart showing an example of a procedure of conveyance control processing when the first printing mode is set. FIG. 6 is a flowchart showing an example of a procedure of conveyance control processing when the second printing mode is set.

### [Conveyance Control Processing in First Printing Mode]

First, the conveyance control processing when the first printing mode is set will be described with reference to FIG. 5. The first printing mode is a printing mode in which, as described above, images are formed on the same side of the recording medium P by the inkjet recording section 322 in each of the first and second rotations of the conveyance of the recording medium P. The first printing mode includes the background printing mode, the additional white printing mode, and the like.

First, the feeder 220 (see FIG. 1) of the feeding device 200 conveys the recording medium P to the temperature control conveyance cylinder 310 (Step S1). Hereinafter, the word “step” in Step Sn (n is a natural number of 2 or more) may be omitted. Next, the temperature control conveyance cylinder 310 conveys the recording medium P to the temperature controlled recording cylinder 321 (S2). Next, the inkjet recording section 322 forms an image (ejects ink) on the recording medium P conveyed by the temperature control recording cylinder 321 (S3). The recording medium P on which the image has been formed on its surface is conveyed along the outer circumferential surface of the temperature control recording cylinder 321 without the fixing processing by the ink curing and drying device 323 being performed.

Next, based on the control by the controller 40, the conveyance path switching section 20 sets the conveyance destination of the recording media P to the temperature control recording cylinder 321 (S4). By execution of the processing of Step S4, the recording medium P makes another round of the outer circumferential surface of the temperature control recording cylinder 321. Next, the controller 40 performs control to turn off heating by the heater H2 and control to turn off detection by the recording medium detector 50 (S5). By execution of the control in Step S5, the recording medium P conveyed along the temperature control recording cylinder 321 can be prevented from being heated by the heater H2. In addition, by execution of the processing of step S5, it is possible to prevent the recording medium P from being detected by the recording medium detector 50. Accordingly, it is possible to prevent the detected recording medium P from being ejected to the ejection tray 431 by the ejection mechanism 410.

Next, the recording medium P conveyed along the temperature control recording cylinder 321 passes immediately below the heater H2 and reaches the position of the inkjet recording section 322 again (S6). When the recording medium P passes immediately below the heater H2, the suction portion 321s (see FIG. 2) of the temperature control recording cylinder 321 generates a suction force on the basis of the control by the controller 40. Thus, the recording medium P is attracted to and held on the outer circumferential surface of the temperature control recording cylinder 321. On the other hand, when the conveyance destination by the conveyance path switching section 20 is set to the first reversing cylinder 331 of the reversing mechanism 330, the controller 40 does not generate the suction force in the suction portion 321s. By execution of such control by the controller 40, the recording medium P can be smoothly delivered from the temperature control recording cylinder 321 to the first reversing cylinder 331.

Next, the inkjet recording section 322 performs the second image formation on the recording media P (S7). In a case where the printing mode is the background printing mode, the inkjet recording section 322 forms an image on the recording medium P on which a background has been formed with white ink or the like. In addition, in a case where the printing mode is the additional white printing mode, the inkjet recording section 322 forms an image with white ink on the recording medium P on which an image has been formed.

Next, the ink curing and drying device 323 performs fixing processing on the recording medium P (S8). Next, the conveyance path switching section 20 switches the conveyance destination of the recording media P to the cylinder 411 of the ejection mechanism 410 (S9). Next, the ejection mechanism 410 ejects the recording medium P to the ejection tray 431 (S10). After the processing of Step 510, the conveyance control processing under the setting of the first print mode ends.

In the above-described embodiment, in the first printing mode such as the background printing mode or the additional white printing mode, the recording medium P is conveyed one more round along the temperature control recording cylinder 321 with the heating by the heater H2 being off. Therefore, according to the present embodiment, printing in the first print mode can be achieved while preventing the recording medium P from being heated by the heater H2 and without once ejecting the recording medium P having an image formed thereon to the ejection tray 431. Therefore, according to the present embodiment, it is possible to save the user the trouble of setting the recording medium P again in the feeding device 200 during printing in the first printing mode.

In addition, in the above-described embodiment, the recording medium P on which the image has been formed in the first rotation of the conveyance makes another round of the outer circumferential surface of the temperature control recording cylinder 321 without the fixing process being performed by the ink curing and drying device 323. That is, according to the present embodiment, the image is formed in the second rotation on the recording medium P in a state where the wettability of the recording medium P on which the image is formed in the first rotation is not changed. Therefore, the ink forming the image to be formed in the rotation time can be prevented from being repelled by the recording medium P. Thus, printing in the first printing mode can be satisfactorily performed.

In addition, in the above-described embodiment, the recording medium P with the ink being uncured is not conveyed to the reversing mechanism 330. Therefore, it is possible to prevent the uncured ink on the recording medium P from adhering to the first reversing cylinder 331 of the reversing mechanism 330.

### [Conveyance Control Processing in Second Printing Mode]

Next, the conveyance control of the recording medium P by the inkjet recording apparatus 1 according to the present embodiment when the second printing mode is set will be described with reference to FIG. 6. As described above, the second printing mode includes the image reading mode.

Since processing from Steps S11 to S13 is identical to the processing from Steps S1 to S3 of FIG. 5, description thereof is omitted. After an image is formed on a recording medium P in Step S13, the ink curing and drying device 323 executes the fixing processing on the recording medium P (S14). Next, the conveyance path switching section 20 sets the conveyance destination of the recording medium P to the temperature control recording cylinder 321 based on the control by the controller 40 (S15). By execution of the processing in Step S15, the recording medium P makes another round of the outer circumferential surface of the temperature control recording cylinder 321.

Next, the controller 40 performs control to turn off heating by the heater H2 and control to turn off detection by the recording medium detector 50 (S16). Next, the controller 40 executes control to change the conveyance speed of the recording medium P by the temperature control recording cylinder 321 to a low speed (S17). More specifically, the controller 40 reduces the conveyance speed of the recording medium P to a speed at which the image reading section 324 can read the image at a high resolution.

The change of the conveyance speed of the recording medium P by the controller 40 is performed from after the image is formed on the recording medium P in the first rotation of conveyance until the image is read by the image reading section 324 in the second rotation. That is, the controller 40 changes the conveyance speed of the recording medium P until the recording medium P on which the image has been formed reaches the position of the image reading section 324 again.

Furthermore, the control to reduce the conveyance speed in the second rotation of the conveyance may be executed when the printing mode is the first printing mode. In a case where the printing mode is the first printing mode, the controller 40 changes the conveyance speed from after the image is formed on the recording medium P in the first rotation of the conveyance until the image is formed by the inkjet recording section 322 in the second rotation. That is, the controller 40 changes the conveyance speed of the recording medium P until the recording medium P on which an image has been formed reaches the position of the inkjet recording section 322 again.

Next, the recording medium P conveyed on the temperature control recording cylinder 321 reaches the position of the image reading section 324 (S18). Next, the image reading section 324 reads the recording medium P on which the image is formed (S19). Next, the conveyance path switching section 20 switches the conveyance destination of the recording medium P to the cylinder 411 of the ejection mechanism 410 based on the control by the controller 40 (S20). Next, the ejection mechanism 410 ejects the recording media P to the ejection tray 431 (S21). After processing of Step S21, the conveyance control processing under the setting of the second printing mode ends.

In the above-described embodiment, in the second printing mode such as the image reading mode, the recording medium P is conveyed another round along the temperature control recording cylinder 321 with the heating by the heater H2 being off. Therefore, according to the present embodiment, it is possible to realize printing in the second printing mode without temporarily ejecting the recording medium P on which an image have been formed to the ejection tray 431 while preventing the recording medium P from being heated by the heater H2. Therefore, according to the present embodiment, it is possible to save the user the trouble of setting the recording medium P again in the feeding device 200 during printing in the second printing mode.

Furthermore, in the above-described embodiment, the controller 40 changes the conveyance speed of the recording medium P in the second rotation of the conveyance to a speed lower than the conveyance speed in the first rotation. Therefore, according to the present embodiment, it is possible to improve the resolution of the reading of the recording medium P performed by the image reading section 324 in the second rotation.

In addition, the controller 40 can improve the resolution of the image formed on the recording medium P by the inkjet recording section 322 in the second rotation by performing the control of decreasing the conveyance speed of the recording medium P in the second rotation when the additional white printing mode is set.

Furthermore, in the above-described embodiment, adding the head 322W to eject white ink to the inkjet recording section 322, it is possible to realize printing in both the background printing mode and the additional white printing mode. That is, it is not necessary to provide a dedicated mechanism or the like for realizing printing in the background printing mode or the additional white printing mode. Therefore, according to the present embodiment, it is possible to prevent the inkjet recording apparatus 1 from becoming large in size.

Although the example in which the ink heads are arranged in the order of W, Y, M, C, and K along the conveyance direction in the inkjet recording section 322 has been described in the above-described embodiment, the present invention is not limited to this. The head 322W to eject color ink may be provided, for example, on the downstream side of the head 322K to eject black ink.

Although the recording medium detector 50 is provided on the upstream side of the heater H2 in the example described in the above-described embodiment, the present invention is not limited this. The recording medium detector 50 may be provided on the downstream side of the heater H2. Thus, the position of the recording medium P can be grasped in a case where the conveyance of the recording medium P is stopped at the time point when the trailing end of the recording medium P passes through the position of the heater H2. Alternatively, the recording medium detector 50 may be provided on both the upstream and downstream sides of the heater H2.

Furthermore, in the above-described embodiment, the example in which the image reading section 324 is provided in the inkjet recording apparatus 1 has been described, but the present invention is not limited thereto. The inkjet recording apparatus according to the present embodiment may be configured not to include the image reading section. In an inkjet recording apparatus that does not include an image reading section, only control related to the first printing mode is performed.

In addition, in the above-described embodiments or modification examples, the configurations of the apparatus and the system have been described in detail and specifically in order to describe them in an easy-to-understand manner, and the present invention is not necessarily limited to those including all of the described configurations.

In addition, control lines and information lines considered to be necessary for description are illustrated in FIG. 3 by solid lines, and all of the control lines and information lines on a product are not necessarily illustrated. In reality, it may be considered that almost all of the components are coupled to each other.

Further, in the present specification, processing steps describing time-series processing include not only processing performed in a time-series manner according to the described order, but also processing performed in parallel or individually (for example, parallel processing or processing by an object), which is not necessarily performed in a time-series manner.

Although embodiments of the present invention have been described and shown in detail, the disclosed embodiments are made for purposes of illustration and example only and not limitation. The scope of the present invention should be interpreted by terms of the appended claims.

What is claimed is:

1. An inkjet recording apparatus comprising:
an image forming section that forms an image by discharging ink onto a recording medium;
a cylindrical conveyance mechanism that conveys the recording medium;
a heating section that heats an outer circumferential surface of the conveyance mechanism;
a switching section that switches a conveyance path of the recording medium between a first conveyance path that does not pass between the conveyance mechanism and the heating section and a second conveyance path that passes between the conveyance mechanism and the heating section; and
a hardware processor that controls switching of the conveyance path by the switching section in accordance with a printing mode,
wherein, when causing the switching section to select the second conveyance path, the hardware processor stops heating by the heating section.

2. The inkjet recording apparatus according to claim 1,
wherein the first conveyance path is a path along which the recording medium is conveyed on the outer circumferential surface of the conveyance mechanism and on an outer circumferential surface of a reversing mechanism that reverses a front and back of the recording medium, and returns to the conveyance mechanism again.

3. The inkjet recording apparatus according to claim 2,
wherein the printing mode in which the hardware processor causes the switching section to select the first conveyance path is a first printing mode in which the image forming section forms an image on a same surface of the recording medium in each of a first rotation and a second rotation of conveyance of the recording medium by the conveyance mechanism, or a second printing mode in which a conveyance speed of the recording medium in the first rotation of the conveyance by the conveyance mechanism is made different from a conveyance speed in the second rotation of the conveyance by the conveyance mechanism.

4. The inkjet recording apparatus according to claim 3, further comprising
a fixing section that fixes the ink on the recording medium by curing the ink landed on the recording medium,
wherein, when the printing mode is the first printing mode, the hardware processor does not cause the fixing section to fix the image that has been formed on the recording medium in the first round and causes the recording medium to be conveyed along the first conveyance path with the ink landed on the recording medium being in an uncured state.

5. The inkjet recording apparatus according to claim 4,
wherein the fixing section performs fixing processing on the recording medium on which the image has been formed by the image forming section in the second rotation.

6. The inkjet recording apparatus according to claim 5,
wherein the hardware processor changes, in the first printing mode or the second printing mode, the conveyance speed of the recording medium by the conveyance mechanism in the second rotation to a lower speed than the conveyance speed in the first round.

7. The inkjet recording apparatus according to claim 6, further comprising:
an image forming section that reads the recording medium on which the image has been formed by the image forming section to generate a read image,
wherein the second printing mode is an image reading mode in which after the image forming section forms the image on the recording medium, the image reading section reads the image on the recording medium.

8. The inkjet recording apparatus according to claim 7,
wherein the hardware processor changes the conveyance speed during a period until the recording medium on which the image has been formed in the first rotation reaches a position of the image reading section.

9. The inkjet recording apparatus according to claim 6,
wherein the hardware processor changes the conveyance speed during a period until the recording medium on which the image has been formed in the first rotation reaches a position of the image forming section.

10. The inkjet recording apparatus according to claim 5, further comprising:
a recording medium detector that detects the recording medium entering between the conveyance mechanism and the heating section,
wherein, when causing the switching section to select the second conveyance path, the hardware processor stops detection by the recording medium detection section.

11. The inkjet recording apparatus according to claim 10, further comprising:
a suction section that suctions the recording medium being conveyed on the outer circumferential surface of the conveyance mechanism,
wherein when causing the switching section to select the second conveyance path, the hardware processor causes the suction section to suction the recording medium to the conveyance mechanism.

12. A conveyance control method comprising:
formation of an image by discharging ink onto a recording medium;
conveyance of the recording medium by a cylindrical conveyance mechanism;
heating of an outer circumferential surface of the conveyance mechanism by a heating section;
switching, by a switching section, of a conveyance path of the recording medium between a first conveyance path that does not pass between the conveyance mechanism and the heating section and a second conveyance path that passes between the conveyance mechanism and the heating section; and
control of the switching of the conveyance path by the switching section in accordance with a printing mode,
wherein in the control, heating by the heating section is stopped when the switching section is caused to select the second conveyance path.
